(19) United States
(12) Patent Application Publication
(10) Pub. No.: US 2018/0005467 A1
(43) Pub. Date: Jan. 4, 2018

(54) MULTI-USER HOTEL TRACKING AND CHECK-IN

(71) Applicant: INTERNATIONAL BUSINESS MACHINES CORPORATION, Armonk, NY (US)

(72) Inventors: Rick A. Hamilton, II, Charlottesville, VA (US); Joanna W. Ng, Unionville (CA); Tinny M.C. Ng, Toronto (CA); Dmitry Rekesh, Pleasanton, CA (US)

(21) Appl. No.: 15/196,138

(22) Filed: Jun. 29, 2016

(51) Int. Cl. G07C 9/00; G06Q 10/02; G06Q 50/12; H04W 4/02

(52) U.S. Cl. CPC G07C 9/00103; H04W 4/023; G07C 9/00119; G06Q 10/02; G07C 9/00015; G06Q 50/12; G07C 2209/08

(57) ABSTRACT

A method for providing hotel room access to a plurality of registered hotel guests is provided. The method may include receiving a plurality of information based on a plurality of devices associated with the plurality of registered hotel guests. The method may further include sending at least one authentication code to the plurality of devices based on the received plurality of information. Additionally, the method may include detecting a plurality of GPS locations associated with the plurality of devices to determine a plurality of proximities of the plurality of devices to at least one hotel room associated with the plurality of registered hotel guests. The method may also include providing hotel room access to the plurality of registered hotel guests based on the determined plurality of proximities of the plurality of devices to the at least one hotel room and based on receiving at least one identifier.

### BACKGROUND

The present invention relates generally to the field of computing, and more specifically, to data communications.

Generally, computer devices may be used to check into hotels and to access hotel rooms. Typically, users/guests may manually book and check-in to hotel rooms, whereby users/guests may receive key cards from a hotel desk attendant to the booked hotel room. Alternatively, a user/guest may be enabled to check-in and access hotel rooms using computer devices. For example, mobile device applications may enable a user to unlock hotel rooms with a wave of the mobile device over the key lock of the hotel rooms.

### SUMMARY

A method for providing hotel room access to a plurality of registered hotel guests is provided. The method may include receiving a plurality of information based on a plurality of devices associated with the plurality of registered hotel guests. The method may further include sending at least one authentication code to the plurality of devices based on the received plurality of information. Additionally, the method may include detecting a plurality of GPS locations associated with the plurality of devices to determine a plurality of proximities of the plurality of devices to at least one hotel room associated with the plurality of registered hotel guests. The method may also include providing hotel room access to the plurality of registered hotel guests based on the determined plurality of proximities of the plurality of devices to the at least one hotel room and based on receiving at least one identifier.

A computer system for providing hotel room access to a plurality of registered hotel guests is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include receiving a plurality of information based on a plurality of devices associated with the plurality of registered hotel guests. The method may further include sending at least one authentication code to the plurality of devices based on the received plurality of information. Additionally, the method may include detecting a plurality of GPS locations associated with the plurality of devices to determine a plurality of proximities of the plurality of devices to at least one hotel room associated with the plurality of registered hotel guests. The method may also include providing hotel room access to the plurality of registered hotel guests based on the determined plurality of proximities of the plurality of devices to the at least one hotel room and based on receiving at least one identifier.

A computer program product for providing hotel room access to a plurality of registered hotel guests is provided. The computer program product may include one or more computer-readable storage devices and program instructions stored on at least one of the one or more tangible storage devices, the program instructions executable by a processor. The computer program product may include program instructions to receive a plurality of information based on a plurality of devices associated with the plurality of registered hotel guests. The computer program product may further include program instructions to send at least one authentication code to the plurality of devices based on the received plurality of information. Additionally, the computer program product may also include program instructions to detect a plurality of GPS locations associated with the plurality of devices to determine a plurality of proximities of the plurality of devices to at least one hotel room associated with the plurality of registered hotel guests. The computer program product may further include program instructions to provide hotel room access to the plurality of registered hotel guests based on the determined plurality of proximities of the plurality of devices to the at least one hotel room and based on receiving at least one identifier.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is an operational flowchart illustrating the steps carried out by a program for providing hotel room access to registered hotel guests according to one embodiment;

FIG. 3 is a block diagram of the system architecture of a program for providing hotel room access to registered hotel guests according to one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to data communication. The following described exemplary embodiments provide a system, method and program product for providing seamless check-in and entry to hotel rooms. Therefore, the present embodiment has the capacity to improve the technical field associated with hotel check-in by enabling users to check into hotels and obtain access to hotel rooms more securely. Specifically, the system, method and program product may enable users to check into hotels and obtain access to hotel rooms using location based services and at least one identifier, such as authorization codes and/or international mobile equipment identification (hereinafter, IMEI) numbers.

As previously described with respect to data communications, a user/guest may be enabled to check-in and access hotel rooms using computer devices. For example, and as previously described, mobile device applications may enable users to unlock hotel rooms with a wave of the mobile device over the key lock of the hotel rooms. Furthermore, to enable users/guests to access the hotel rooms using the mobile devices, typical mobile device applications use IMEI numbers that are associated with the mobile devices to authenticate the mobile device and enable users/guests to unlock hotel room doors. However, authenticating users/guests based on IMEI numbers presents security risks, specifically when individuals steal users/guests' IMEI numbers and use the stolen IMEI numbers to gain access to the users/guests' hotel rooms. Additionally, typical mobile device applications do not provide multiple users/guests with access to a hotel room using the mobile devices. As such, it may be advantageous, among other things, to provide a system, method and program product for providing room access to users/guests by authenticating users/guests based on locations of computer devices associated with the users/guests and at least one identifier. Specifically, the system, method, and program product may provide users/guests access to hotel rooms by authenticating users/guests based on detecting proximities of users/guests' computer devices to hotel rooms as well as at least one authentication code and/or IMEI number.

According to at least one implementation of the present embodiment, computer device information associated with users/guests may be received. Next, based on the received computer devices information, at least one authentication code may be sent to the computer devices. Then, GPS locations associated with the computer devices may be detected. Next, room access may be provided to the users/guests by detecting proximities of the computer devices to hotel rooms using the detected GPS locations as well as by detecting IMEI numbers and/or receiving the sent authentication codes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for providing room access to users/guests by authenticating users/guests based on a location associated with users/guests' computer devices and at least one identifier.

According to at least one implementation, computer device information associated with users/guests may be received. Next, based on the received computer devices information, at least one authentication code may be sent to the computer devices. Then, GPS locations associated with the computer devices may be detected. Next, room access may be provided to the users/guests by detecting proximities of the computer devices to hotel rooms using the detected GPS locations as well as by detecting IMEI numbers and/or receiving the sent authentication codes.

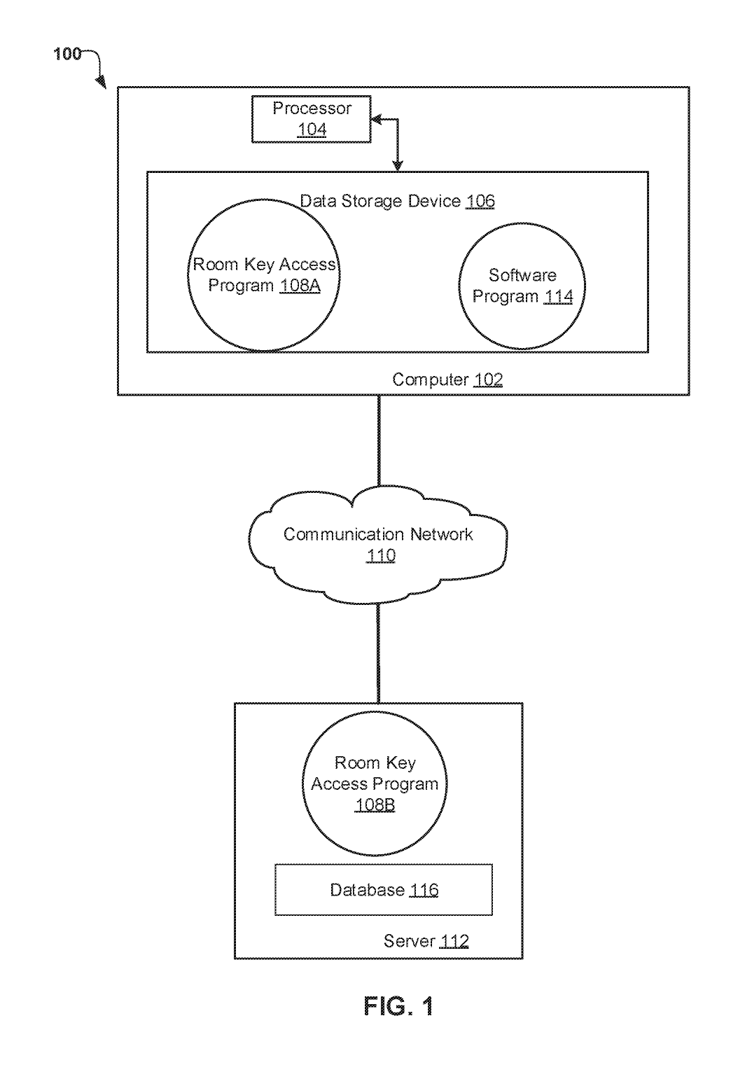

Referring now to FIG. 1, an exemplary networked computer environment 100 in accordance with one embodiment is depicted. The networked computer environment 100 may include a computer 102 with a processor 104 and a data storage device 106 that is enabled to run a room key access program 108A and a software program 114. The software program 114 may be an application program such as hotel application program. The room key access program 108A may communicate with the software program 114. The networked computer environment 100 may also include a server 112 that is enabled to run a room key access program 108B and a communication network 110. The networked computer environment 100 may include a plurality of computers 102 and servers 112, only one of which is shown for illustrative brevity.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

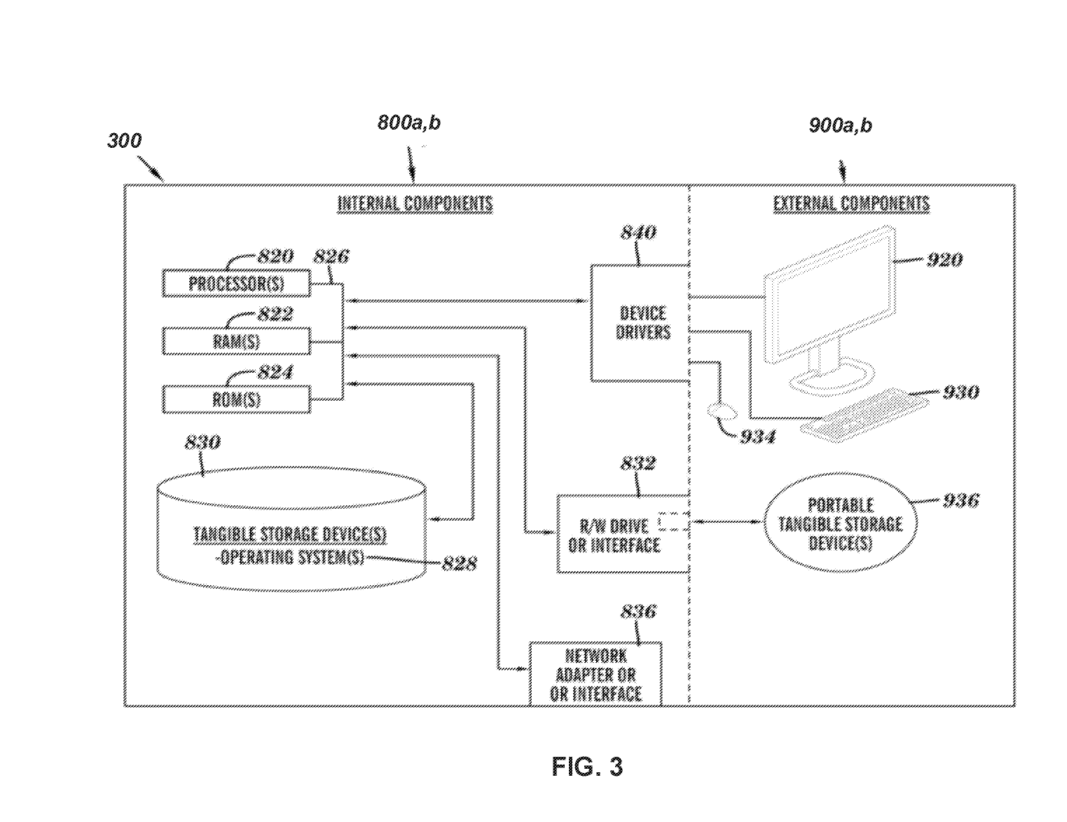

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the room key access program 108A, 108B may interact with a database 116 that may be embedded in various storage devices, such as, but not limited to, a mobile device 102, a networked server 112, or a cloud storage service.

According to the present embodiment, a program, such as a room key access program 108A and 108B may run on the client computer 102 or on the server computer 112 via a communications network 110. The room key access program 108A, 108B may provide room access to users/guests by authenticating users/guests based on GPS locations associated with users/guests' computer devices and at least one identifier. Specifically, a user using a computer, such as computer 102, may run a room key access program 108A, 108B, that may interact with a software program 114, to provide users/guests access to hotel rooms by authenticating users/guests based on detected proximities of users/guests' computer devices to hotel rooms as well as by receiving authentication codes and/or detecting IMEI numbers.

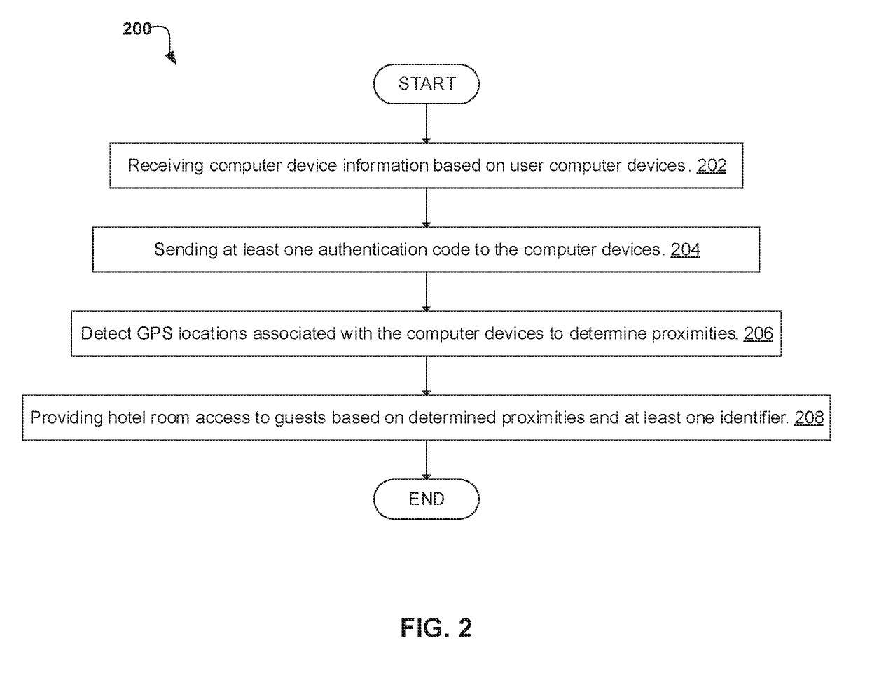

Referring now to FIG. 2, an operational flowchart 200 illustrating the steps carried out by a program for providing room access to users/guests is depicted. At 202, the room key access program 108A, 108B (FIG. 1) may receive computer device information based on computer devices that are associated with users/guests. For example, and as previously described, a user may use a computer 102 (FIG. 1), such as a mobile phone device, to register for a hotel room on a software program 114 (FIG. 1) by entering user/guest information as well as user/guest computer device information that may include the user's mobile phone number and the user's email address. Thereafter, the room key access program 108A, 108B (FIG. 1) may interact with the software program 114 (FIG. 1) to receive the computer device information that may include the user's mobile phone number and/or email address.

Next, at 204, the room key access program 108A, 108B (FIG. 1) may send at least one authentication code to the computer devices based on the received computer device information. As previously described at step 202, the room key access program 108A, 108B (FIG. 1) may receive computer device information that may include the user's mobile phone number. Thereafter, according to one embodiment, the room key access program 108A, 108B (FIG. 1) may send at least one authentication code to the user's mobile phone number based on the received user/guest computer device information. For example, the room key access program 108A, 108B (FIG. 1) may send an authentication code that may include a string of alphanumeric and non-alphanumeric characters to the user's mobile device upon receiving the user/guest computer device information.

Then, at 206, the room key access program 108A, 108B (FIG. 1) may detect GPS locations associated with the computer devices to determine proximities of the computer devices to the hotel rooms. As previously described at step 202, the room key access program 108A, 108B (FIG. 1) may receive user/guest computer device information that is associated with a computer device based on the user registering for a hotel room. Furthermore, according to one embodiment, based on the user/guest computer device location based services, the room key access program 108A, 108B (FIG. 1) may detect the GPS location of the user/guest computer device. As such, based on the detected GPS location of the user/guest computer device, the room key access program 108A, 108B (FIG. 1) may determine the proximities of the computer devices to the hotel rooms. Additionally, according to one embodiment, instead of detecting GPS locations, the room key access program 108A, 108B (FIG. 1) may detect Bluetooth or beacon technology associated with the computer devices to determine proximities of the computer devices to the hotel and/or hotel rooms. For example, the room key access program 108A, 108B (FIG. 1) may detect the location of the user/guest computer device using beacon technology when the user/guest computer device enters a hotel and/or when a GPS location associated with the user/guest computer device is unavailable.

Next, at 208, the room key access program 108A, 108B (FIG. 1) may provide hotel room access to the users/guests based on the determined proximity of the users/guests' computer devices to the hotel rooms and at least one identifier. Specifically, the room key access program 108A, 108B (FIG. 1) may provide hotel room access to the user/guest by determining that the user/guest computer device is in close proximity to the hotel room, whereby determining close proximity may include determining that the user/guest computer device GPS location is at, or in front of, the hotel room door. Furthermore, according to one embodiment, the room key access program 108A, 108B (FIG. 1) may provide hotel room access to the users/guests based on the determined proximity of the user/guest computer device to the hotel room and receiving at least one identifier, whereby the at least one identifier may include at least one seamlessly detected IMEI number associated with the computer device. Specifically, for example, the room key access program 108A, 108B (FIG. 1) may seamlessly detect the IMEI number using radio frequency (RF) that may include BLE (Bluetooth Low Energy) and Near Field Communication (NFC). Also, according to one embodiment, the room key access program 108A, 108B (FIG. 1) may provide hotel room access to the users/guests based on the determined proximity of the user/guest computer device to the hotel room and receiving at least one identifier, whereby receiving the at least one identifier may include receiving user input of the authentication code. Specifically, for example, the room key access program 108A, 108B (FIG. 1) may receive the users/guests using a keypad to input the authentication code sent to the computer devices associated with the users/guests.

It may be appreciated that FIG. 2 provides only illustrations of one implementation and does not imply any limitations with regard to how different embodiments may be implemented. Many modifications to the depicted environments may be made based on design and implementation requirements. For example, at step 204, the room key access program 108A, 108B (FIG. 1) may send the at least one authentication code to the computer devices associated with the users/guests at determined times, such as at a response time in response to receiving the information associated with the devices, at an arrival time such as 24 hours before an arrival date of the registered user/guest, or at a time based on the computer devices GPS locations in response to determining that the GPS location of the user/guest computer device is at or near the hotel room door. Furthermore, the room key access program 108A, 108B (FIG. 1) may deactivate the authentication code when the user checks out of the hotel room.

FIG. 3 is a block diagram 300 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 3. Each of the sets of internal components 800 a, b includes one or more processors 820, one or more computer-readable RAMs 822, and one or more computer-readable ROMs 824 on one or more buses 826, and one or more operating systems 828 and one or more computer-readable tangible storage devices 830. The one or more operating systems 828, the software program 114 (FIG. 1) and the room key access program 108A (FIG. 1) in client computer 102 (FIG. 1), and the room key access program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as a room key access program 108A and 108B (FIG. 1), can be stored on one or more of the respective portable computer-readable tangible storage devices 936, read via the respective R/W drive or interface 832, and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The room key access program 108A (FIG. 1) and software program 114 (FIG. 1) in client computer 102 (FIG. 1), and the room key access program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the room key access program 108A (FIG. 1) and software program 114 (FIG. 1) in client computer 102 (FIG. 1) and the room key access program 108B (FIG. 1) in network server computer 112 (FIG. 1) are loaded into the respective hard drive 830. The network may comprise copper wires, optical fibers, wireless transmission, routers, firewalls, switches, gateway computers, and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930, and computer mouse 934. The device drivers 840, R/W drive or interface 832, and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

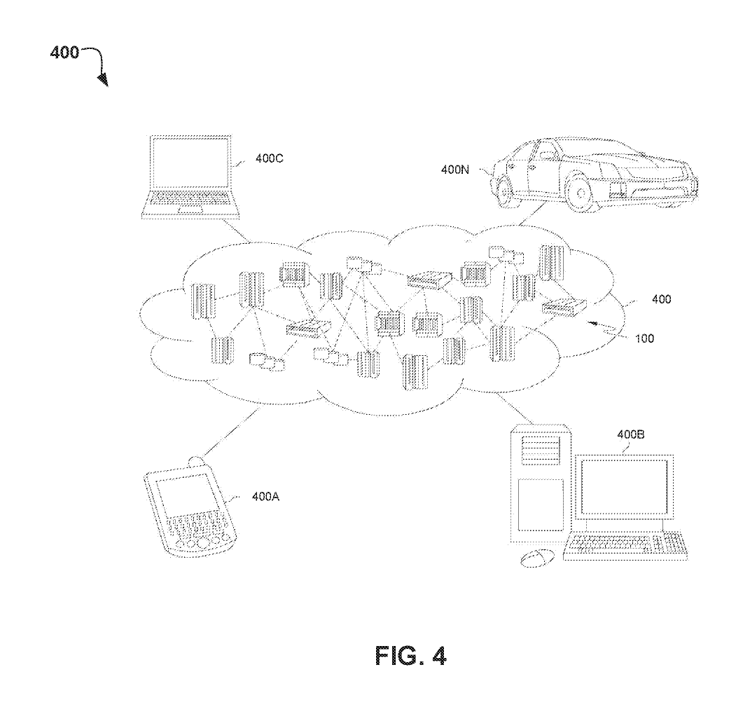

Referring now to FIG. 4, illustrative cloud computing environment 400 is depicted. As shown, cloud computing environment 400 comprises one or more cloud computing nodes 100 with which local computing devices used by cloud consumers, such as, for example, personal digital assistant (PDA) or cellular telephone 400A, desktop computer 400B, laptop computer 400C, and/or automobile computer system 400N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 400A-N shown in FIG. 4 are intended to be illustrative only and that computing nodes 100 and cloud computing environment 400 can communicate with any type of computerized device over any type of network and/or network addressable connection (e.g., using a web browser).

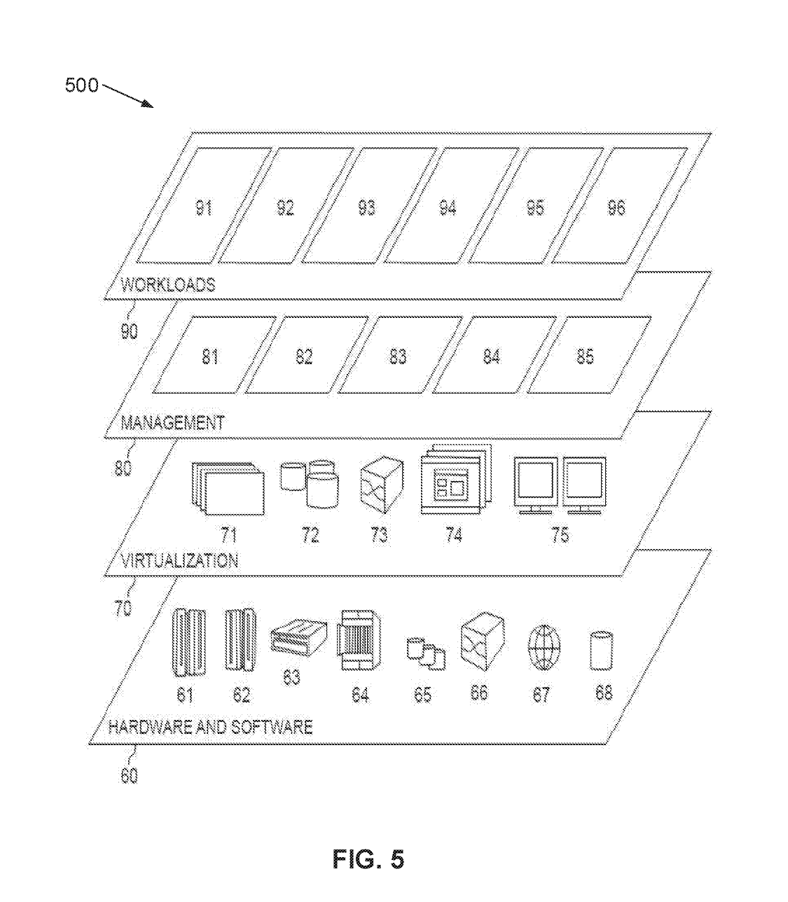

Referring now to FIG. 5, a set of functional abstraction layers 500 provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and room key access 96. A room key access program 108A, 108B (FIG. 1) may be offered “as a service in the cloud” (i.e., Software as a Service (SaaS)) for applications running on mobile devices 102 (FIG. 1) and may provide hotel room access to registered hotel guests based on computer device location and at least one identifier.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for providing hotel room access to a plurality of registered hotel guests, the method comprising:
receiving a plurality of information based on a plurality of devices associated with the plurality of registered hotel guests;
based on the received plurality of information, sending at least one authentication code to the plurality of devices at a specified time, wherein the specified time is associated with an arrival time;
detecting a plurality of GPS locations associated with the plurality of devices to determine a plurality of proximities of the plurality of devices to at least one hotel room associated with the plurality of registered hotel guests; and
providing hotel room access to the plurality of registered hotel guests based on the determined plurality of proximities of the plurality of devices to the at least one hotel room and based on receiving at least one identifier.

2. The method of claim 1, wherein the received plurality of information comprises at least one mobile phone number and at least one email address.

3. (canceled)

4. The method of claim 1, wherein sending the at least one authentication code further comprises:
sending the at least one authentication code based on the determined plurality of proximities of the plurality of devices to the at least one hotel room.

5. The method of claim 1, wherein providing hotel room access to the plurality of registered hotel guests based on the determined plurality of proximities further comprises:
determining whether the plurality of devices associated the plurality of registered hotel guests are in proximity of a door associated with at the at least one hotel room.

6. The method of claim 1, wherein the at least one identifier is selected from a group consisting of at least one of an authorization code associated with the sent plurality of authorization codes based on a user action, and an international mobile equipment identification (IMEI) number.

7. The method of claim 1, further comprising:
in response to the plurality of devices entering at least one hotel associated with the at least one hotel room, or in response to an unavailable GPS location associated with the plurality of devices, detecting a plurality of locations associated with the plurality of devices based on beacon technology to determine the plurality of proximities of the plurality of devices to the at least one hotel room associated with the plurality of registered hotel guests.

8. A computer system for providing hotel room access to a plurality of registered hotel guests, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving a plurality of information based on a plurality of devices associated with the plurality of registered hotel guests;
based on the received plurality of information, sending at least one authentication code to the plurality of devices at a specified time, wherein the specified time is associated with an arrival time;
detecting a plurality of GPS locations associated with the plurality of devices to determine a plurality of proximities of the plurality of devices to at least one hotel room associated with the plurality of registered hotel guests; and
providing hotel room access to the plurality of registered hotel guests based on the determined plurality of proximities of the plurality of devices to the at least one hotel room and based on receiving at least one identifier.

9. The computer system of claim 8, wherein the received plurality of information comprises at least one mobile phone number and at least one email address.

10. (canceled)

11. The computer system of claim 8, wherein sending the at least one authentication code further comprises:
sending the at least one authentication code based on the determined plurality of proximities of the plurality of devices to the at least one hotel room.

12. The computer system of claim 8, wherein providing hotel room access to the plurality of registered hotel guests based on the determined plurality of proximities further comprises:
determining whether the plurality of devices associated the plurality of registered hotel guests are in proximity of a door associated with at the at least one hotel room.

13. The computer system of claim 8, wherein the at least one identifier is selected from a group consisting of at least one of an authorization code associated with the sent plurality of authorization codes based on a user action, and an international mobile equipment identification (IMEI) number.

14. The computer system of claim 8, further comprising:
in response to the plurality of devices entering at least one hotel associated with the at least one hotel room, or in response to an unavailable GPS location associated with the plurality of devices, detecting a plurality of locations associated with the plurality of devices based on beacon technology to determine the plurality of proximities of the plurality of devices to the at least one hotel room associated with the plurality of registered hotel guests.

15. A computer program product for providing hotel room access to a plurality of registered hotel guests, comprising:
one or more computer-readable storage devices and program instructions stored on at least one of the one or more tangible storage devices, the program instructions executable by a processor, the program instructions comprising:
program instructions to receive a plurality of information based on a plurality of devices associated with the plurality of registered hotel guests;
based on the received plurality of information, program instructions to send at least one authentication code to the plurality of devices at a specified time, wherein the specified time is associated with an arrival time;
program instructions to detect a plurality of GPS locations associated with the plurality of devices to determine a plurality of proximities of the plurality of devices to at least one hotel room associated with the plurality of registered hotel guests; and
program instructions to provide hotel room access to the plurality of registered hotel guests based on the determined plurality of proximities of the plurality of devices to the at least one hotel room and based on receiving at least one identifier.

16. (canceled)

17. The computer program product of claim 15, wherein the program instructions to send the at least one authentication code further comprises:
program instructions to send the at least one authentication code based on the determined plurality of proximities of the plurality of devices to the at least one hotel room.

18. The computer program product of claim 15, wherein the program instructions to provide hotel room access to the plurality of registered hotel guests based on the determined plurality of proximities further comprises:
program instructions to determine whether the plurality of devices associated the plurality of registered hotel guests are in proximity of a door associated with at the at least one hotel room.

19. The computer program product of claim 15, wherein the at least one identifier is selected from a group consisting of at least one of an authorization code associated with the sent plurality of authorization codes based on a user action, and an international mobile equipment identification (IMEI) number.

20. The computer program product of claim 15, further comprising:
in response to the plurality of devices entering at least one hotel associated with the at least one hotel room, or in response to an unavailable GPS location associated with the plurality of devices, detecting a plurality of locations associated with the plurality of devices based on beacon technology to determine the plurality of proximities of the plurality of devices to the at least one hotel room associated with the plurality of registered hotel guests.
